(19) United States
(12) Patent Application Publication
(10) Pub. No.: US 2016/0338149 A1
(43) Pub. Date: Nov. 17, 2016

(54) HEATING RESISTOR

(71) Applicant: BorgWarner Ludwigsburg GmbH, Ludwigsburg (DE)

(72) Inventors: Stephen Sweeney, Ballinorig (IE); Anthony Maher, Foynes (IE); Katherine O'Sullivan, Co. Kerry (IE)

(21) Appl. No.: 15/149,485

(22) Filed: May 9, 2016

(30) Foreign Application Priority Data
May 11, 2015 (DE) 10 2015 107 322.6

(51) Int. Cl. H05B 3/14; H01C 7/04; H01C 7/02

(52) U.S. Cl. CPC H05B 3/141; H01C 7/022; H01C 7/042

(57) ABSTRACT

Disclosed is a heating resistor comprising a body of a ceramic PTC resistor material with at least one face of the body coated by a layer of an NTC material. The combination of a PTC resistor and an NTC resistor limits the inrush current at the beginning of a heating process when the PTC resistor is still cold and therefore has a low electrical resistance. When the resistor is heated, the electrical resistance of the NTC resistor decreases while the electrical resistance of the PTC resistor increases. Thus, the electric current changes less until the PTC resistor reaches its critical temperature where its electrical resistance increases by several orders of magnitude. The lowering of electrical current at the beginning of the heating process is especially advantageous in applications that rely on a limited power supply, for example a car battery.

### RELATED APPLICATIONS

This application claims priority to DE 10 2015 107 322.6, filed May 11, 2015, which is hereby incorporated herein by reference in its entirety.

### BACKGROUND

The invention relates to a heating resistor for an electrical heating device and a method for manufacturing a heating resistor.

Ceramic PTC (Positive Temperature Coefficient) heating resistors are commonly used in various electrical heating devices because such resistors show an increase in their electrical resistance of several orders of magnitude above a critical temperature. In case of overheating the increase in electrical resistance reduces the heating power so much that a further increase in temperature is prevented. Thus, ceramic PTC heating resistors offer an inherent protection from damage by overheating. Ceramic PTC resistors are usually based on barium titanate or other ferroelectric materials.

### SUMMARY

This disclosure teaches how ceramic PTC heating resistors can be improved.

A heating resistor according to this disclosure comprises a ceramic PTC heating resistor that is coated on at least one face by a layer of an NTC resistor material (Negative Temperature Coefficient). The NTC resistor material can be a printed layer. For example, the NTC layer can be printed directly onto the ceramic PTC body or onto an intermediate layer.

The combination of a PTC resistor and an NTC resistor limits the inrush current at the beginning of a heating process when the PTC resistor is still cold and therefore has a low electrical resistance. When the resistor is heated, the electrical resistance of the NTC resistor decreases while the electrical resistance of the PTC resistor increases. Thus the electric current changes less until the PTC resistor reaches its critical temperature where its electrical resistance increases by several orders of magnitude. The lowering of electrical current at the beginning of the heating process is especially advantageous in applications that rely on a limited power supply, for example a car battery.

Although a limitation of inrush current can also be achieved by connecting separate NTC and PTC resistor parts in series, the combination of NTC and PTC resistors in a single part that can be easily handled simplifies the manufacturing of a heating device. Moreover, separate NTC and PTC resistors must be correctly connected in series to be effective, which is a possible source of error during assembly. This source of error is eliminated by a heating resistor according to this disclosure wherein an NTC layer is connected to PTC body by a substance to substance bond.

An advantageous refinement of this disclosure is that an intermediate layer can be arranged between the PTC body and the NTC layer. The intermediate layer may improve or provide a substance to substance bond between the PTC body and the NTC layer. The intermediate layer may be a metallic layer or a ceramic layer. The intermediate layer may coat all faces of the body, but preferably coats only a single face of the body or two opposing faces, e.g., the upper and lower faces of a disk or strip. The upper and lower faces of a strip are the faces that together form the predominant part of the total surface of a strip or a disk.

This disclosure also refers to a method for manufacturing a heating resistor. The method comprises providing a ceramic PTC resistor and depositing a layer of an NTC material onto the ceramic PTC resistor. The layer may be applied as a paste and then fired.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an embodiment of a heating resistor according to this disclosure.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

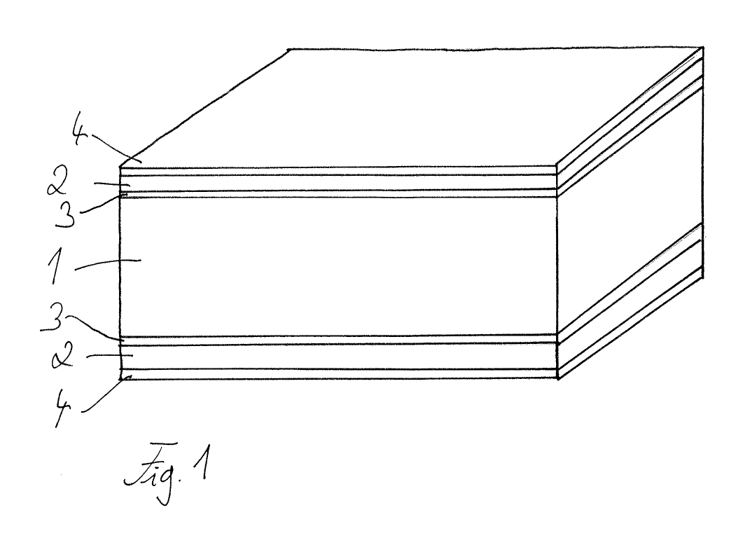

The heating resistor shown in FIG. 1 comprises a body 1 consisting of a ceramic PTC material, e.g., a ceramic based on barium titanate. The body 1 carries a layer 2 of a ceramic NTC material. The NTC material may for example be based on oxides of Mn. Ni, Co, Cu, and/or Ti, for example. The oxides may be mixed with a binder to form a paste that is then applied to the body 1, e.g., by printing and later firing.

The NTC layer 2 coats at least one face of the PTC body 1. In the embodiment shown, the NTC layer 2 coats two opposite faces of the PTC body 1. In this way the contribution of the NTC material to the total electrical resistance of the heating resistor is increased. This is especially advantageous if the NTC layer 2 is relatively thin. The NTC 2 layer may coat all faces of the PTC body 1, e.g., if it was applied by an immersion process.

Between the body 1 of ceramic PTC material and the layer 2 of NTC material may be an intermediate layer 3. The intermediate layer 3 can improve the mechanical and electrical connection of the NTC layer 2 to the PTC body 1. The intermediate layer 3 can be a metallic layer, e.g., an aluminium layer. The NTC layer 2 may also be deposited directly onto the PTC body 1. In any case, a material connection is created between the NTC layer 2 and the PTC body 1.

The NTC layer 2 may be covered by a metallic layer 4 to facilitate an electrical connection of the heating resistor. The metallic layer 4 may be deposited by electroplating, vapour deposition or any other coating method.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A heating resistor, comprising:
a body of a ceramic PTC resistor material; and
a layer of NTC material coated on at least one face of the body.

2. The heating resistor according to claim 1, wherein the NTC material is a ceramic NTC material.

3. The heating resistor according to claim 1, wherein the layer is a printed layer.

4. The heating resistor according to claim 1, wherein the body is a disk.

5. The heating resistor according to claim 1, wherein the body is a cuboid.

6. The heating resistor according to claim 1, wherein an intermediate layer is arranged between the body and the NTC layer.

7. The heating resistor according to claim 1, wherein the intermediate layer is a metallic layer.

8. The heating resistor according to claim 1, wherein the at least one face of the body comprises an upper face and a lower face, the layer of the NTC material being deposited on the upper and lower faces.

9. The heating resistor according to claim 1, wherein the layer of NTC material directly contacts the at least one face of the body.
